(19) United States
(12) Patent Application Publication
(10) Pub. No.: US 2009/0250259 A1
(43) Pub. Date: Oct. 8, 2009

(54) Multilayered printed circuit board and method of manufacturing the same

(75) Inventors: Jee Soo Mok, Gyunggi-do (KR); Je Gwang Yoo, Gyunggi-do (KR); Chang Sup Ryu, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/216,435

(22) Filed: Jul. 3, 2008

(30) Foreign Application Priority Data
Apr. 3, 2008 (KR) 10-2008-0031246

(51) Int. Cl. H01R 12/02; B05D 5/12; B32B 38/10

(52) U.S. Cl. 174/263; 427/97.5; 156/344

(57) ABSTRACT

Disclosed herein is a multilayered printed circuit board, including: a build-up layer including a plurality of insulating layers and a plurality of circuit layers; an insulating resin layer, including bumps, formed on the outermost circuit layer of one side of the build-up layer; and a solder resist layer formed on the outermost layer of the other side of the build-up layer. The multilayered printed circuit board is manufactured by sequentially placing a build-up layer and a solder resist layer on one side of an insulating resin layer, the other side of which is provided with bumps. The present invention is advantageous in that the thickness of the multilayered printed circuit board is decreased, the production processes thereof is simplified, and the production efficiency is increased.

### CROSS REFERENCE TO RELATED APPLICATION

This application claims the benefit of Korean Patent Application No. 10-2008-0031246, filed Apr. 3, 2008, entitled “Multilayered printed circuit board and a method of fabricating the same”, which is hereby incorporated by reference in its entirety into this application.

### BACKGROUND OF THE INVENTION

1. Field of the Invention

The present invention relates to a multilayered printed circuit board and a method of manufacturing the same, and, more particularly, to a method of manufacturing a multilayered printed circuit board which makes it possible to decrease the thickness of the multilayered printed circuit board, simplify the production process thereof and increase the production efficiency thereof, and to a multilayered circuit board manufactured using the method.

2. Description of the Related Art

Generally, printed circuit boards (PCBs) are manufactured by patterning one or both sides of a substrate, composed of various thermosetting resins, using copper foil, and disposing and fixing ICs or electronic parts on the substrate, thus forming electric circuits therebetween.

Recently, with the advancement of the electronics industry, electronic parts are increasingly required to be highly functionalized, and to be light, thin, short and small. Printed circuit boards loaded with such electronic parts are also required to be highly densified and thin.

In particular, since conventional build-up circuit boards are used as products in a state in which a build-up layer is formed on a core substrate, there is a problem in that the thickness of the build-up circuit board is increased. That is, when the thickness of the build-up circuit board is increased, there is also a problem in that the length of the circuit is increased, so that the signal processing time is increased, thereby preventing the circuit from being highly densified.

In order to overcome the above problems, a coreless substrate having no core has been proposed. FIG. 1 shows a conventional process of manufacturing a coreless substrate. Hereinafter, the conventional process of manufacturing a coreless substrate will be described with reference to FIG. 1.

First, as shown in FIG. 1A, a metal carrier 10, used to support a coreless substrate during the process, is prepared.

Subsequently, as shown in FIG. 1B, a metal barrier 11 is formed on one surface of the metal carrier 10, and a circuit pattern 12 is formed on the metal barrier 11.

Subsequently, as shown in FIG. 1C, a build-up layer 13, including a plurality of insulation layers and a plurality of circuit layers, is formed on the circuit pattern 12. Here, the build-up layer is formed using a general build-up method.

Subsequently, as shown in FIG. 1D, the metal carrier 10 and the metal barrier are removed.

Finally, as shown in FIG. 1E, solder resist layers 14 are formed on the uppermost and lowermost layers of the build-up layer 13, thereby manufacturing a coreless substrate 15.

As such, the conventional coreless substrate 15 is manufactured by forming a build-up layer 13 using a metal carrier 10 as a support and then removing the metal carrier therefrom.

However, the conventional method of manufacturing a coreless substrate 15 is problematic in that, since the metal carrier 10 functions only as a support during the process, an additional process for removing the metal carrier 10 is required, and solder resist layers 14 must be additionally formed in order to protect the circuit layer, which is exposed after the removal of the metal carrier 10.

### SUMMARY OF THE INVENTION

Accordingly, the present invention has been made keeping in mind the above problems occurring in the prior art, and the present invention provides a method of manufacturing a multilayered printed circuit board, in which an additional PSR process is not required because a support functions both to support the circuit board and to protect the outermost circuit layer, and a multilayered printed circuit board manufactured using the method.

Further, the present invention provides a method of manufacturing a multilayered printed circuit board, which can increase the productivity of the multilayered printed circuit board by attaching a pair of supports and then forming build-up layers on both sides thereof, and a multilayered printed circuit board manufactured using the method.

A first aspect of the present invention provides a multilayered printed circuit board, including: a build-up layer including a plurality of insulating layers and a plurality of circuit layers; an insulating resin layer, including bumps, formed on an outermost circuit layer of one side of the build-up layer; and a solder resist layer formed on an outermost layer of the other side of the build-up layer.

Here, the bumps are formed in the insulating resin layer such that they penetrate the insulating resin layer.

Further, the bumps are formed of silver (Ag) paste.

Further, the bumps have a conical shape.

Further, solder ball pads formed on the outermost layer of the build-up layer are exposed through openings formed in the solder resist layer.

Further, solder balls are attached to the solder ball pads.

A second aspect of the present invention provides a method of manufacturing a multilayered printed circuit board, including: forming an insulating resin layer on one side of a support provided with bumps; removing the support to form an insulation supporting layer; forming a build-up layer including a plurality of insulating layers and a plurality of circuit layers on the insulation supporting layer; and forming a solder resist layer on an outermost layer of the build-up layer.

In this case, in the forming of the insulating resin layer, the thickness of the insulating resin layer formed on the support is greater than the height of the bumps.

In addition, the method of manufacturing a multilayered printed circuit board according to the second aspect of the present invention further includes, after the forming of the solder resist layer, partially removing the insulating resin layer in the direction of the thickness of the multilayered printed circuit board such that the bumps are exposed.

Further, the insulating resin layer is removed through LDA (laser direct ablation).

Further, the insulating resin layer is formed on the support by coating the support with a resin using an ink-jet printing method.

A third aspect of the present invention provides a method of manufacturing a multilayered printed circuit board, including: forming an insulating resin layer on one side of a support provided with bumps; removing the support to form an insulation supporting layer; aligning a pair of insulation supporting layers such that surfaces of the insulation supporting layers on which the supports are not formed face each other and then adhering the pair of insulation supporting.layers to each other using an adhesive; forming a build-up layer including a plurality of insulating layers and a plurality of circuit layers on each of the insulation supporting layers; forming a solder resist layer on an outermost layer of each of the build-up layers; and separating the insulation supporting layers, on which the pair of build-up layers and the pair of solder resist layers are formed, from each other.

In this case, in the forming of the insulating resin layer, the thickness of the insulating resin layer formed on the support is greater than the height of the bumps.

Further, the method of manufacturing a multilayered printed circuit board according to the third aspect of the present invention, further includes: after the separating the insulation supporting layers, partially removing the insulating resin layer in the direction of the thickness of the multilayered printed circuit board such that the bumps are exposed.

Further, the insulating resin layer is removed through LDA (laser direct ablation).

Further, the insulating resin layer is formed on the support by coating the support with a resin using an ink-jet printing method.

Further, the adhesive is a thermal adhesive exhibiting non-adhesiveness after heat treatment.

A fourth aspect of the present invention provides a method of manufacturing a multilayered printed circuit board, including: forming an insulating resin layer on one side of a copper foil layer provided with bumps; patterning the copper foil layer to form a circuit layer; forming a build-up layer including a plurality of insulating layers and a plurality of circuit layers on the circuit layer; and forming a solder resist layer on the outermost layer of the build-up layer.

In this case, in the forming of the insulating resin layer, the thickness of the insulating resin layer formed on the copper foil layer is greater than the height of the bumps.

Further, the method of manufacturing a multilayered printed circuit board according to the fourth aspect of the present invention, further includes, after the forming of the solder resist layer, partially removing the insulating resin layer in the direction of the thickness of the multilayered printed circuit board such that the bumps are exposed.

A fifth aspect of the present invention provides a method of manufacturing a multilayered printed circuit board, including: forming an insulating resin layer on one side of a copper foil layer provided with bumps; aligning a pair of insulating resin layers such that surfaces of the insulating resin layers on which the copper foil layers are not formed face each other and then adhering the pair of insulating resin layers to each other using an adhesive; patterning each of the copper foil layers to form a circuit layer; forming a build-up layer including a plurality of insulating layers and a plurality of circuit layers on each of the circuit layers; forming a solder resist layer on the outermost layer of each of the build-up layers; and separating the insulating resin layers, on which the pair of build-up layers and the pair of solder resist layers are formed, from each other through heat treatment.

In this case, in the forming of the insulating resin layer, the thickness of the insulating resin layer formed on the copper foil layer is greater than the height of the bumps.

Further, the method of manufacturing a multilayered printed circuit board according to the fifth aspect of the present invention further includes: after the separating of the insulating resin layers, partially removing the insulating resin layer in the direction of the thickness of the multilayered printed circuit board such that the bumps are exposed.

Further, the adhesive is a thermal adhesive exhibiting non-adhesiveness after heat treatment.

### BRIEF DESCRIPTION OF THE DRAWINGS

The above and other objects, features and advantages of the present invention will be more clearly understood from the following detailed description taken in conjunction with the accompanying drawings, in which:

FIGS. 1A-1E are sectional views illustrating a conventional method of manufacturing a multilayered printed circuit board;

FIG. 2 is a sectional view showing a multilayered printed circuit board according to an embodiment of the present invention;

FIGS. 3A-3F are sectional views illustrating a method of manufacturing a multilayered printed circuit board according to a first embodiment of the present invention; and

FIGS. 4A-4H are sectional views illustrating a method of manufacturing a multilayered printed circuit board according to a second embodiment of the present invention.

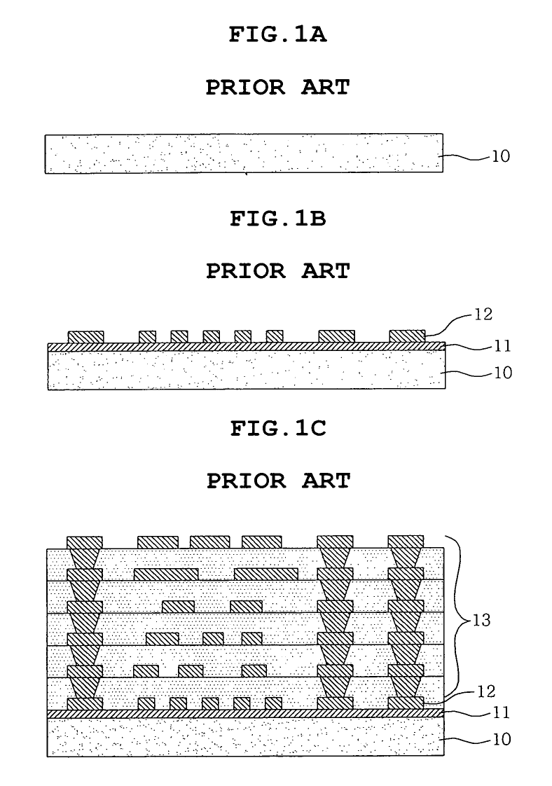

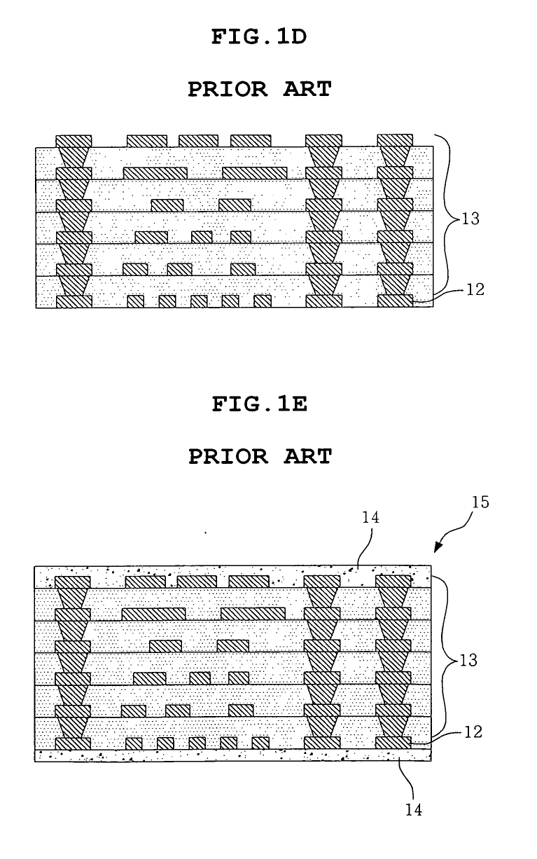

### DESCRIPTION OF THE PREFERRED EMBODIMENTS

Hereinafter, preferred embodiments of the present invention will be described in detail with reference to the attached drawings.

Reference now should be made to the drawings, in which the same reference numerals are used throughout the different drawings to designate the same or similar components.

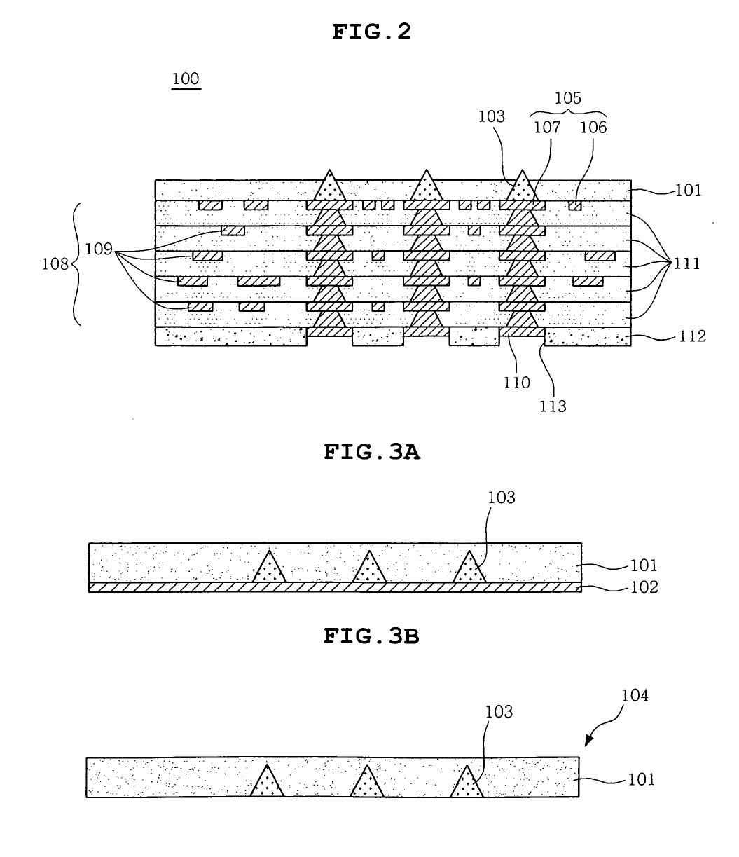

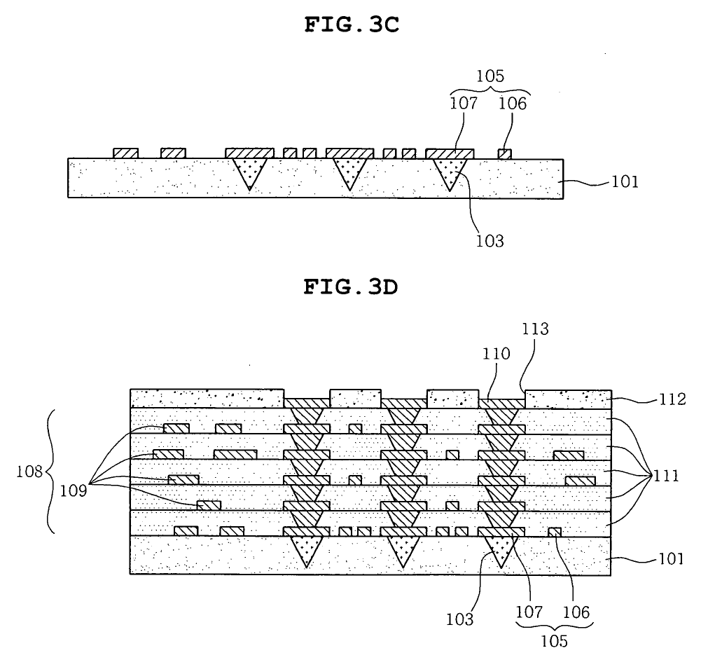

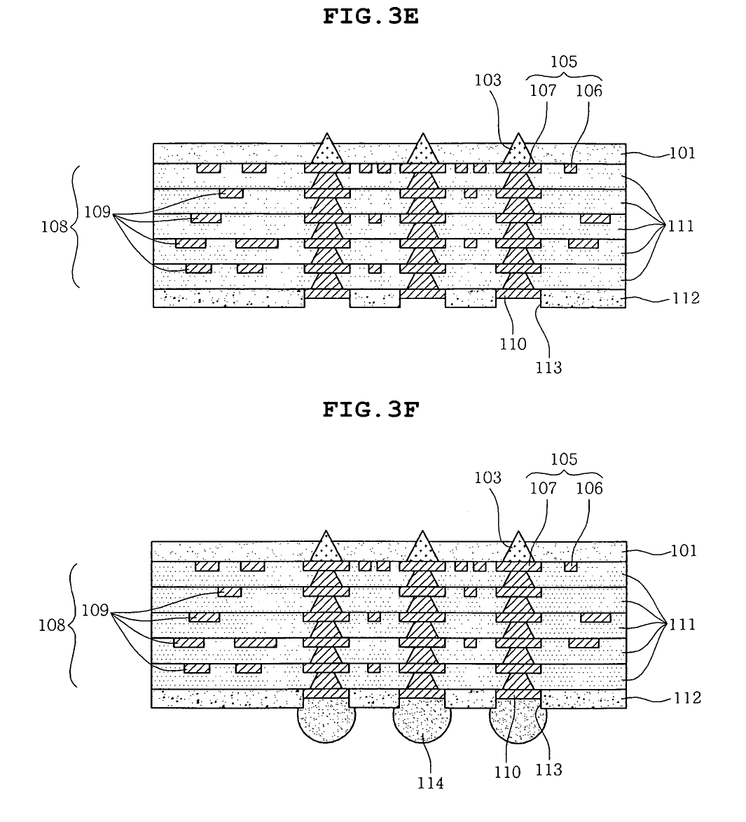

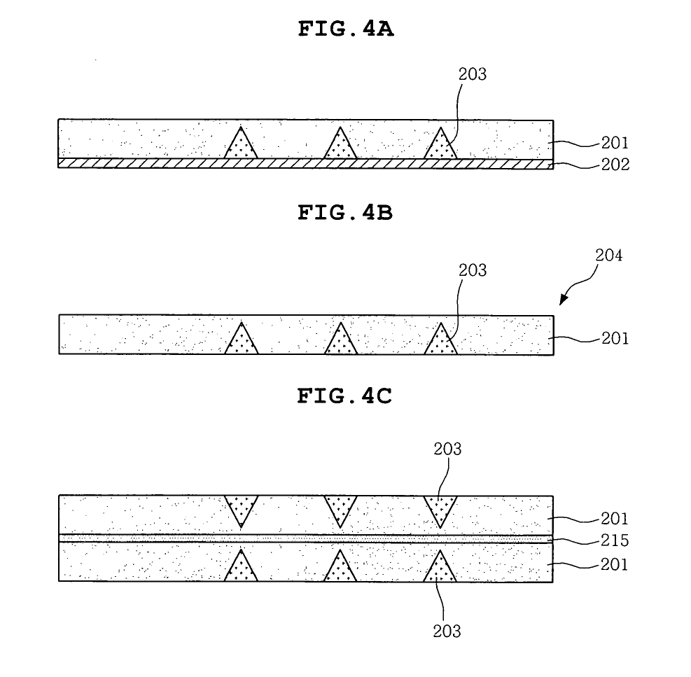

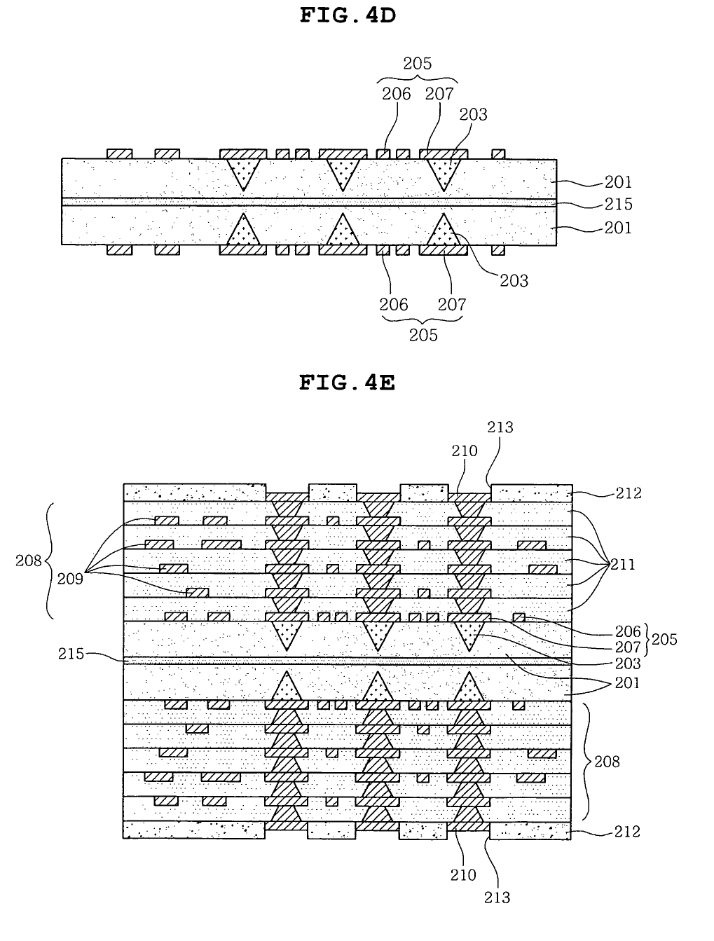

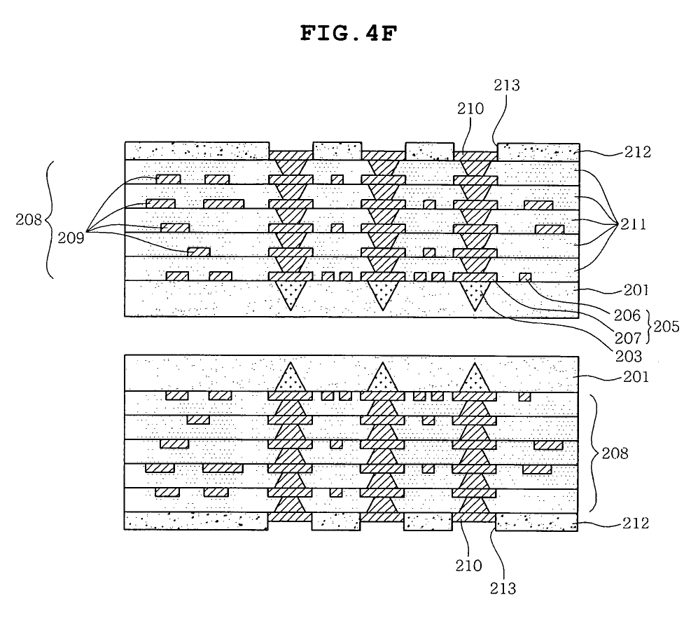

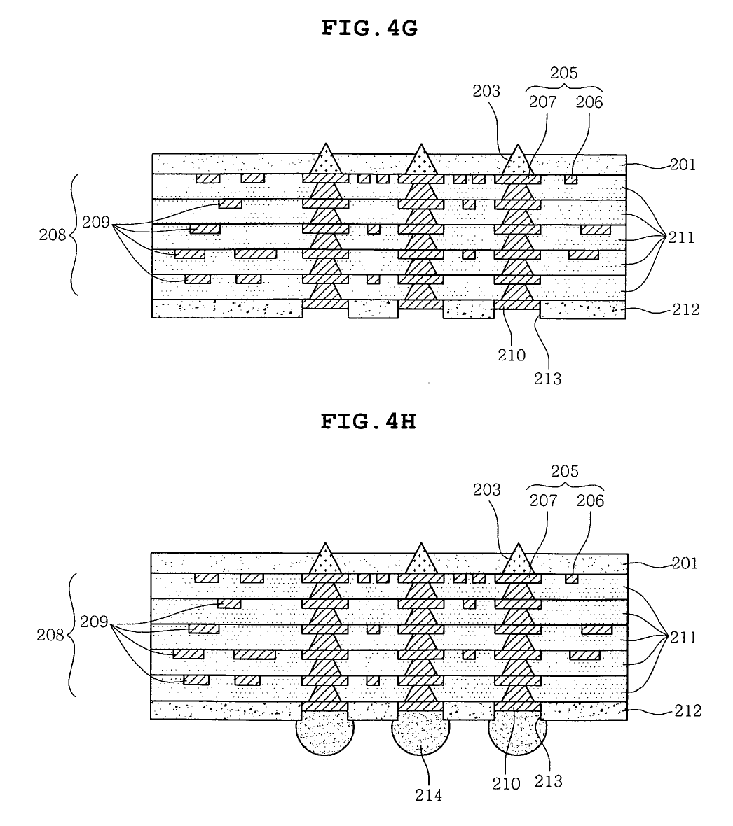

FIG. 2 is a sectional view showing a multilayered printed circuit board according to an embodiment of the present invention, FIG. 3 is sectional views illustrating a method of manufacturing a multilayered printed circuit board according to a first embodiment of the present invention, and FIG. 4 is sectional views illustrating a method of manufacturing a multilayered printed circuit board according to a second embodiment of the present invention.

Hereinafter, a multilayered printed circuit board according to an embodiment of the present invention will be described with reference to FIG. 2.

The multilayered printed circuit board 100 according to an embodiment of the present invention includes a build-up layer 108, an insulating resin layer 101, and a solder resist layer 112.

The build-up layer 108 includes a plurality of insulating layers 111 and a plurality of circuit layers 109.

Here, a circuit layer 105, including circuit patterns 106 and lands 107, is formed in the outermost layer of one side of the build-up layer 108, and protruding solder ball pads 110 are formed on the outermost layer of the other side of the build-up layer 108. Solder balls for connecting a main board or electronic parts therewith may be attached to the solder ball pads 110.

The insulating resin layer 101 functions to support the build-up layer 108, prevent the oxidation of a circuit layer formed in the outermost layer of one side of the build-up layer 108, and electrically insulate the circuit layer. The outermost circuit layer 105 is formed on one side of the insulating resin layer 101, and bumps 103 are formed in the insulating resin layer 101.

Here, the insulating resin layer 101 may be formed of a commonly-used epoxy resin, a glass epoxy resin, an alumina-containing epoxy resin, or the like, but the present invention is not limited thereto.

The bumps 103, serving to connect external electronic parts with the multilayered printed circuit board 100, are printed on the lands 107, and, preferably, are formed through the insulating resin layer 101.

Here, the bumps 103 may be formed of conductive paste, such as Ag, Pd, Pt, Ni, or Ag-Pd paste. Further, the bumps 103 have a conical structure, and thus they can come into very precise contact with external electronic parts.

The solder resist layer 112, serving to prevent the oxidation of a circuit layer formed in the outermost layer of the other side of the build-up layer 108 and electrically insulate the circuit layer, is formed on the outermost layer of the build-up layer 108, and is provided therein with openings 113 to expose the solder ball pads 110 formed on the outermost layer of the build-up layer 108.

Hereinafter, a method of manufacturing a multilayered printed circuit board according to a first embodiment of the present invention will be described with reference to FIGS. 3A to 3F.

First, as shown in FIG. 3A, an insulating resin layer 101 is formed on a support 102 printed thereon with bumps 103. In this case, it is preferred that the thickness of the insulating resin layer 101 be greater than the height of the bumps 103.

Here, it is preferred that the support 102 have a predetermined strength or more such that the bumps 103 can be printed on the support 102. For example, the support 102 may be formed of metals or polymers, particularly peelable polymers. An example of a support may be copper foil.

The bumps 103 may be printed using a screen printing method. The screen printing method is a method of printing bumps through a conductive paste transfer process using a mask having openings therein. That is, in the screen printing method, the openings of the mask are aligned, and then conductive paste is applied on the mask. Subsequently, when the conductive paste is squeegeed, the conductive paste is transferred to the support 102 while being extruded through the openings, thus printing bumps having a desired shape and height. The bumps 103 may also be printed using other commonly-known printing methods, which fall within the scope of the present invention.

The insulating resin layer 101 is formed on the support 102 such that the thickness of the insulating resin layer 101 is greater than the height of the bumps 103, and may be formed using a contact method or a non-contact method.

Here, the contact method is a method of placing the insulating resin layer 101 on the support 102 printed with the bumps 103. In the contact method, it is preferred that the bumps 103 have strength greater than that of the insulating resin layer 101 such that the bumps 103 can penetrate the insulating resin layer 101, and that the insulating resin layer 101 be a semi-cured prepreg formed of thermosetting resin. Since the insulating resin layer 101 has a thickness greater than the height of the bumps 103, the bumps 103 partially penetrate the insulating resin layer 101 to the height of the bumps 103.

Meanwhile, the non-contact method is a method of coating the support 102 with insulating resin powder using an ink-jet printing method. The non-contact method is advantageous in that problems, such as the change in the shape of the bumps 103 occurring due to the force generated when the bumps 13 penetrate into the insulating resin layer 101 or the formation of fine gaps between the bumps 103 and the insulating resin layer 101, can be minimized.

Subsequently, as shown in FIG. 3B, the support 102 is removed to form an insulation supporting layer 104 in which the bumps 103 are formed in the insulating resin layer 101. The insulation supporting layer 104, which will be described later, serves to support a build-up layer 108 which will be formed on the insulation supporting layer during the process.

Subsequently, as shown in FIG. 3C, a circuit layer 105 is formed on one side of the insulating resin layer 101, from which the support 102 has been removed, using a general semi-additive method.

Here, the circuit layer 105 includes circuit patterns 106 and lands 107, and the lands 107 are formed on the bumps 103.

Subsequently, as shown in FIG. 3D, a build-up layer 108 including a plurality of insulating layers 111 and a plurality of circuit layers 109 is formed on the circuit layer 105 using a general build-up method, and a solder resist layer 112 is formed on the outermost layer of the build-up layer 108.

In this case, the build-up layer 108 may be formed using a build-up method. Protruding solder ball pads 110 are formed on the outermost layer of the build-up layer 108.

Meanwhile, openings 113 are formed in the solder resist layer 112 such that the solder ball pads 110, formed on the outermost layer of the build-up layer 108, are exposed to be connected with other electronic parts or a main board. The openings 113 may be formed through LDA (Laser Direct Ablation) or mechanical drilling.

Further, the insulating layers 111 may be formed of a commonly-used epoxy resin, a glass epoxy resin, an alumina-containing epoxy resin, or the like, but the present invention is not limited thereto. Further, the thickness of the insulating layers 111 may be variously changed if necessary, and, as described above, the insulating layers can be thinly formed because they are supported by the insulation supporting layer 104.

Through the above processes, the multilayered printed circuit board 100 according to an embodiment of the present invention is manufactured.

Further, as shown in FIG. 3E, it is preferred that the insulating resin layer 101 be partially removed in the direction of the thickness of the multilayered printed circuit board such that the bumps 103 formed in the insulating resin layer 101 are exposed to be connected with other electronic parts, etc.

In this case, the insulating resin layer 101, but the bumps 103 formed therein, is partially removed through LDA.

Meanwhile, since the insulating resin layer 101 functions as a solder resist layer for protecting the outermost circuit layer, an additional PSR process is not required.

Furthermore, as shown in FIG. 3F, solder balls 114 for connecting a main board or electronic parts therewith may be attached to the solder ball pads 110 of the multilayered printed circuit board manufactured through the above processes.

Meanwhile, the multilayered printed circuit board shown in FIG. 2 may be manufactured using a copper foil layer as a support 102.

That is, bumps 103 are printed on one side of the copper foil layer, and then an insulating resin layer 101, having a thickness greater than the thickness of the printed bumps 103, is formed thereon. Subsequently, a circuit layer 105 is formed by patterning this copper foil layer, and then the processes shown in FIGS. 3D to 3F are conducted, thereby manufacturing the multilayered printed circuit board shown in FIG. 2.

This method of manufacturing a multilayered printed circuit board using a copper foil layer is advantageous in that, since the copper foil layer used as a support 102 is used to form a circuit layer 105, a process of removing the copper foil layer is not required, and it is not required to use an additional copper foil layer in order to form the circuit layer 105, thus reducing the cost of materials.

Hereinafter, a method of manufacturing a multilayered printed circuit board according to a second embodiment of the present invention will be described with reference to FIGS. 4A to 4H.

The method of manufacturing a multilayered printed circuit board according to the second embodiment of the present invention is conducted in the same way as the method of manufacturing a multilayered printed circuit board according to the second embodiment of the present invention, except that a double-sided multilayered printed circuit board is manufactured by adhering two insulation supporting layers provided with bumps to each other, and is then divided into two multilayered printed circuit boards, thereby simultaneously manufacturing the two multilayered printed circuit boards. Therefore, the method of manufacturing a multilayered printed circuit board according to the second embodiment of the present invention will be briefly described, avoiding repetitive descriptions.

First, as shown in FIG. 4A, an insulating resin layer 201 is formed on a support 202 printed thereon with bumps 203. In this case, it is preferred that the thickness of the insulating resin layer 201 be greater than the height of the bumps 203.

Subsequently, as shown in FIG. 4B, the support 202 is removed to form an insulation supporting layer 204 in which the bumps 203 are formed in the insulating resin layer 201.

Subsequently, as shown in FIG. 4C, a pair of insulation supporting layers 204 is aligned such that the surfaces of the two insulation supporting layers on which supports 202 are not formed face each other, and is then adhered to each other using a thermal adhesive 215.

In this case, it is preferred that a pair of insulation supporting layers 204 be aligned such that the surfaces of the two insulation supporting layers on which supports 202 are not formed face each other. For instance, when the bumps 203 formed in the insulation supporting layer 204 have a conical shape, since the pointed portions of the bumps 203 are to be connected to electronic products later and thus must be exposed, the insulation supporting layers 204 must be aligned such that the pointed portions of the bumps 203 can be exposed by subsequently removing the insulating resin layer 201.

The thermal adhesive 215 is a material exhibiting non-adhesiveness after heat treatment. All commonly-known thermal adhesives may be used as the thermal adhesive 215 without limitation as long as the thermal adhesive maintains adhesiveness in a state in which it is adhered to an adherend at room temperature, but loses adhesiveness upon heat treatment, and thus can be separated from the adherend. For example, a thermal adhesive including an acrylic resin exhibiting non-adhesiveness after heat treatment at a temperature of about 100˜150° C. and a foaming agent may be used, but the present invention is not limited thereto. Meanwhile, it is preferred that this thermal adhesive 215 do not lose adhesiveness at process temperatures such that the insulation supporting layers adhered to the thermal adhesive 215 are not separated, but that they lose adhesiveness at temperatures higher than the process temperatures.

Subsequently, as shown in FIG. 4D, a circuit layer 205 is formed on one side of each of the insulating resin layers 201, from which the support 202 is removed, using a general semi-additive method.

Subsequently, as shown in FIG. 4E, a build-up layer 208 including a plurality of insulating layers 111 and a plurality of circuit layers 209 is formed on each of the circuit layers 205 using a general build-up method, and a solder resist layer 212 is formed on the outermost layer of each of the build-up layers 208.

In this case, protruding solder ball pads 210 are formed on the outermost layer of each of the build-up layers 208, and openings 213 are formed in each of the solder resist layers 212 such that the solder ball pads 210 are exposed.

Subsequently, as shown in FIG. 4F, the respective insulation supporting layers 204, on which a pair of build-up layers 208 and a pair of solder resist layers 212 are formed, are separated from each other.

As described above, since the thermal adhesive 215 loses adhesiveness upon heat treatment and can thus be separated from an adherend, the respective insulation supporting layers 204, on which a pair of build-up layers 208 and a pair of solder resist layers 212 are formed, are separated from each other by heating the thermal adhesive 215.

Through the above processes, a multilayered printed circuit board according to the present invention is manufactured.

Further, as shown in FIG. 4G, it is preferred that the insulating resin layer 201 be partially removed in the direction of the thickness of the multilayered printed circuit board such that the bumps 203 formed in the insulating resin layer 201 are exposed to be connected with other electronic parts, etc.

Furthermore, as shown in FIG. 4H, solder balls 214 for connecting a main board or electronic parts therewith may be attached to the solder ball pads 210 of the multilayered printed circuit board manufactured through the above processes.

Meanwhile, as described above, in the method of manufacturing a multilayered printed circuit board according to the second embodiment of the present invention, the multilayered printed circuit board can be manufactured using a copper foil layer as a support 202, and an additional process of removing the support 202 is not required, and the copper foil layer is used to form a circuit layer, thus reducing the process time and material cost.

As described above, according to the present invention, the thickness of a multilayered printed circuit board can be reduced because an insulation supporting layer functions to support the multilayered circuit board, and an additional PSR process is not required because the insulation supporting layer functions as a solder resist layer for electrically insulating a circuit layer.

Further, the productivity of the multilayered circuit board can be increased because a pair of insulation supporting layers is adhered to each other and build-up layers are formed on both sides thereof.

Further, bumps, which are formed in an insulation supporting layer, serve to help the insulation supporting layer to support a multilayered printed circuit board, and function as connection parts for connecting the multilayered printed circuit board with electronic parts.

Furthermore, bumps can come into very precise contact with external electronic parts because they have a conical shape.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A multilayered printed circuit board, comprising:
a build-up layer including a plurality of insulating layers and a plurality of circuit layers;
an insulating resin layer, including bumps, formed on an outermost circuit layer of one side of the build-up layer; and
a solder resist layer formed on an outermost layer of the other side of the build-up layer.

2. The multilayered printed circuit board according to claim 1, wherein the bumps are formed in the insulating resin layer such that they penetrate the insulating resin layer.

3. The multilayered printed circuit board according to claim 1, wherein the bumps are formed of silver (Ag) paste.

4. The multilayered printed circuit board according to claim 1, wherein the bumps have a conical shape.

5. The multilayered printed circuit board according to claim 1, wherein solder ball pads formed on the outermost layer of the build-up layer are exposed through openings formed in the solder resist layer.

6. The multilayered printed circuit board according to claim 5, wherein solder balls are attached to the solder ball pads.

7. A method of manufacturing a multilayered printed circuit board, comprising:
forming an insulating resin layer on one side of a support provided with bumps;
removing the support to form an insulation supporting layer;
forming a build-up layer including a plurality of insulating layers and a plurality of circuit layers on the insulation supporting layer; and
forming a solder resist layer on an outermost layer of the build-up layer.

8. The method of manufacturing a multilayered printed circuit board according to claim 7, wherein, in the forming the insulating resin layer, a thickness of the insulating resin layer formed on the support is greater than a height of the bumps.

9. The method of manufacturing a multilayered printed circuit board according to claim 8, further comprising: after the forming the solder resist layer, partially removing the insulating resin layer in a direction of a thickness of the multilayered printed circuit board such that the bumps are exposed.

10. The method of manufacturing a multilayered printed circuit board according to claim 9, wherein the insulating resin layer is removed through LDA (laser direct ablation).

11. The method of manufacturing a multilayered printed circuit board according to claim 7, wherein the insulating resin layer is formed on the support by coating the support with a resin using an ink-jet printing method.

12. A method of manufacturing a multilayered printed circuit board, comprising:
forming an insulating resin layer on one side of a support provided with bumps;
removing the support to form an insulation supporting layer;
aligning a pair of insulation supporting layers such that surfaces of the insulation supporting layers on which the supports are not formed face each other and then adhering the pair of insulation supporting layers to each other using an adhesive;
forming a build-up layer including a plurality of insulating layers and a plurality of circuit layers on each of the insulation supporting layers;
forming a solder resist layer on an outermost layer of each of the build-up layers; and
separating the insulation supporting layers, on which the pair of build-up layers and the pair of solder resist layers are formed, from each other.

13. The method of manufacturing a multilayered printed circuit board according to claim 12, wherein, in the forming the insulating resin layer, a thickness of the insulating resin layer formed on the support is greater than a height of the bumps.

14. The method of manufacturing a multilayered printed circuit board according to claim 13, further comprising: after the separating the insulation supporting layers, partially removing the insulating resin layer in a direction of a thickness of the multilayered printed circuit board such that the bumps are exposed.

15. The method of manufacturing a multilayered printed circuit board according to claim 14, wherein the insulating resin layer is removed through LDA (laser direct ablation).

16. The method of manufacturing a multilayered printed circuit board according to claim 12, wherein the insulating resin layer is formed on the support by coating the support with a resin using an ink-jet printing method.

17. The method of manufacturing a multilayered printed circuit board according to claim 12, wherein the adhesive is a thermal adhesive exhibiting non-adhesiveness after heat treatment.

18. A method of manufacturing a multilayered printed circuit board, comprising:
forming an insulating resin layer on one side of a copper foil layer provided with bumps;
patterning the copper foil layer to form a circuit layer;
forming a build-up layer including a plurality of insulating layers and a plurality of circuit layers on the circuit layer; and
forming a solder resist layer on an outermost layer of the build-up layer.

19. The method of manufacturing a multilayered printed circuit board according to claim 18, wherein, in the forming the insulating resin layer, a thickness of the insulating resin layer formed on the copper foil layer is greater than a height of the bumps.

20. The method of manufacturing a multilayered printed circuit board according to claim 19, further comprising: after the forming the solder resist layer, partially removing the insulating resin layer in a direction of a thickness of the multilayered printed circuit board such that the bumps are exposed.

21. A method of manufacturing a multilayered printed circuit board, comprising:
forming an insulating resin layer on one side of a copper foil layer provided with bumps;
aligning a pair of insulating resin layers such that surfaces of the insulating resin layers on which the copper foil layers are not formed face each other and then adhering the pair of insulating resin layers to each other using an adhesive;
patterning each of the copper foil layers to form a circuit layer;
forming a build-up layer including a plurality of insulating layers and a plurality of circuit layers on each of the circuit layers;
forming a solder resist layer on an outermost layer of each of the build-up layers; and
separating the insulating resin layers, on which the pair of build-up layers and the pair of solder resist layers are formed, from each other through heat treatment.

22. The method of manufacturing a multilayered printed circuit board according to claim 21, wherein, in the forming the insulating resin layer, a thickness of the insulating resin layer formed on the copper foil layer is greater than a height of the bumps.

23. The method of manufacturing a multilayered printed circuit board according to claim 22, further comprising: after the separating the insulating resin layers, partially removing the insulating resin layer in a direction of a thickness of the multilayered printed circuit board such that the bumps are exposed.

24. The method of manufacturing a multilayered printed circuit board according to claim 21, wherein the adhesive is a thermal adhesive exhibiting non-adhesiveness after heat treatment.
